(19) United States
(12) Patent Application Publication
(10) Pub. No.: US 2024/0389102 A1
(43) Pub. Date: Nov. 21, 2024

(54) METHOD FOR COMPUTING AN ESTIMATED DATA AVAILABILITY FOR UPLINK CONTROL DATA

(71) Applicant: JOHN MEZZALINGUA ASSOCIATES, LLC., Liverpool, NY (US)

(72) Inventors: Jaeweon Kim, Cedar Park, TX (US); Jon Mitchell Martin, Carrollton, TX (US); Yan Shi, Mckinney, TX (US); Alex Elisa Chandra, Plano, TX (US)

(21) Appl. No.: 18/693,462

(22) PCT Filed: Jun. 15, 2023
(86) PCT No.: PCT/US23/25449

§ 371 Date: Mar. 19, 2024

Related U.S. Application Data
(60) Provisional application No. 63/352,767, filed on Jun. 16, 2022.

(51) Int. Cl. H04W 72/21

(52) U.S. Cl. CPC H04W 72/21

(57) ABSTRACT

A method for computing an estimated data availability for UCI (Uplink Control Information) in an LTE or 5G system enables a base station (e.g., eNodeB or gNodeB) to estimate how much data is available within its allocated PUSCH (Physical Uplink Shared Channel) data for the UCI data. The method enables a UE to insert a sufficient amount of UCI data without consuming resources required for the PUSCH data, thereby preventing decode failures.

### BACKGROUND OF THE INVENTION

### Field of the Invention

The present invention relates to wireless communications, and more particularly, to a method for enabling proper allocation of bits for cellular communications.

### Related Art

According to the 3GPP (Third Generation Partnership Project) specifications for 4G and 5G, a device, such as a mobile device or UE (User Equipment) transmits data over the air using allocated Resource Elements (REs) that are organized into Resource Blocks (RBs) allocated to it by the base station (eNodeB for 4G, gNodeB for 5G). A given UE's Resource Elements comprise a plurality of time and frequency slots in a Resource Grid that is composed of slots in the time domain and subcarriers in the frequency domain. A given UE transmits its data in a logical channel known as a PUSCH (Physical Uplink Shared Channel). Along with the user data in the PUSCH, the UE transmits additional information regarding the nature of the radio link between the UE and the eNodeB/gNodeB. This information, known as Uplink Control Information (UCI) is UE-specific and can be transmitted through the PUCCH (Physical Uplink Control channel) or multiplexed by the UE into an allocation field within the Resource Elements allocated to PUSCH data.

When multiplexed with a PUSCH, the UCI data (in the form of messages) contains information such as a hybrid automatic repeat request acknowledgement (HARQ-ACK), channel state information (CSI) part 1 and part 2. However, a problem may arise when a lot of information is included in the UCI message. The number of resource elements (RE) for the PUSCH data is reduced accordingly which can result in 1) reduced uplink throughput, and/or 2) increased data decoding error.

In order to achieve the best performance of the wireless network and to effectively multiplex a UE's UCI messages into its PUSCH data, an efficient method of computing a proper number of UCI bits is needed.

### SUMMARY OF THE DISCLOSURE

An aspect of the present disclosure involves a method for estimating a number of available bits for transmitting UCI (Uplink Control Information) from a UE (User Equipment). The method comprises computing a number of available bits for transmission and a transport block size; setting a maximum effective coding rate corresponding to a PUSCH (Physical Uplink Shared Channel) decoder and a maximum effective UCI coding rate corresponding to a PUCCH (Physical Uplink Control Channel) decoder; computing a maximum number of encoded UCI bits; computing a maximum number of encoded UCI bits adjusted for satisfying an effective coding rate; computing a multiplier to convert the number of UCI input bits based on a number of encoded UCI bits; and computing a maximum number of allowed input UCI bits for each of a plurality of UCI types.

Another aspect of the present disclosure involves a non-transitory memory encoded with machine readable instructions that, when executed by a processor, causes the processor to implement a process. The process comprises computing a number of available bits for transmission and a transport block size; setting a maximum effective coding rate corresponding to a PUSCH (Physical Uplink Shared Channel) decoder and a maximum effective UCI (Uplink Control Information) coding rate corresponding to a PUCCH (Physical Uplink Control Channel) decoder; computing a maximum number of encoded UCI bits; computing a maximum number of encoded UCI bits adjusted for satisfying an effective coding rate; computing a multiplier to convert the number of UCI input bits based on a number of encoded UCI bits; and computing a maximum number of allowed UCI bits for each of a plurality of UCI types.

### BRIEF DESCRIPTION OF THE DRAWINGS

FIG. 1 illustrates an exemplary scenario in which a plurality of UEs communicate with a base station (e.g., eNodeB/gNodeB), including Uplink transmission of PUSCH data with UCI data.

FIG. 2 illustrates an exemplary process for estimating the amount of data available for UCI according to the disclosure.

### DESCRIPTION OF EXEMPLARY EMBODIMENTS

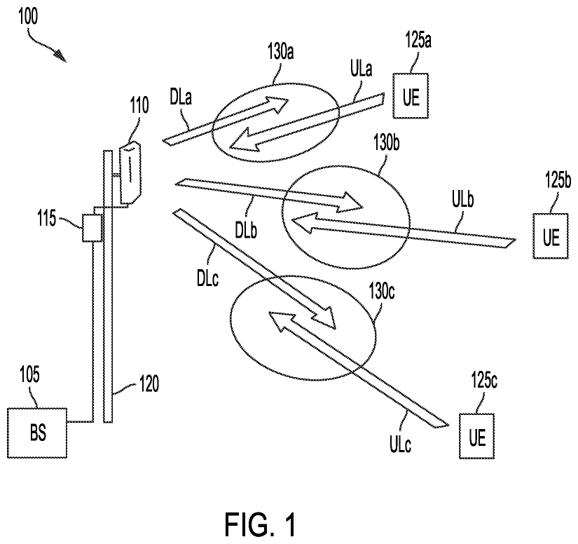

FIG. 1 illustrates an exemplary scenario 100 in which a plurality of UEs 125a, 125b, and 125c communicate with a base station 105 according to the disclosure. As used herein, base station 105 may refer to, for example, an eNodeB (LTE) or gNodeB (5G). As illustrated, base station 105 is coupled to a remote radio head 115, which is coupled to an antenna 110. Antenna 110 and remote radio head 115 may be deployed on a cell tower 120, or may be deployed in an in-building or dense urban setting, in which case tower 120 might not be present.

Base station 105 may communicate with each UE 125a/b/c (via remote radio head 115 and antenna 110) by transmitting downlink signals DLa to UE 125a, downlink signals DLb to UE 125b, and downlink signals DLc to UE 125c. Although three distinct downlink signals DLa, DLb, and DLc are depicted, it will be understood that more UEs may be present and may communicate with base station 105 in a similar fashion. These three downlink signals DLa/DLb/DLc may occur within a single cell sector, and these downlink signals DLa/DLb/DLc may occupy distinct

Resource Blocks (comprising Resource Elements) in a single Resource Grid of one slot in the time domain and subcarriers in the frequency domain. As more UEs connect to base station 105, each UE may be allocated fewer Resource Elements on the Resource Grid to accommodate the additional UEs. Similarly, each UE 125a/b/c transmits data to base station 105 over a respective uplink signal ULa, ULb, and ULc. The uplink signals may be similarly implemented whereby each UE 125a/b/c is allocated a unique set of Resource Elements on an uplink Resource Grid that is shared by the UEs. Each UE 125a/b/c transmits its respective user data in a Physical Uplink Shared Channel (PUSCH) that is part of the UE's uplink signal ULa/ULb/ULc. In a TDD (Time Division Duplex) scenario, the Resource Grid with the downlink signals DLa/DLb/DLc are transmitted by base station 105 (via antenna 110) and the Resource Grid with the uplink signals collectively transmitted by the UEs 125a/b/c respectively at alternating times.

Although UEs 125a/b/c share a single Resource Grid for their downlink signals DLa/DLb/DLc and another Resource Grid for their uplink signals ULa/ULb/ULc, the uplink and downlink signals for each UE 125a/b/c propagate through a distinct propagation medium 130a/b/c, which may distinctly distort a given UE's respective uplink and downlink signals. To identify, characterize, and potentially compensate for this UE-specific distortion, each UE 125a/b/c transmits Uplink Control Information (UCI) to base station 105. In doing so, each UE 125a/b/c may transmit its respective UCI within its designated PUCCH (Physical Uplink Control Channel), or it may multiplex its UCI into the UE's PUSCH.

Whether the UE transmits the UCI in a dedicated PUCCH or multiplexes it into its PUSCH is determined by base station 105, whereby a MAC (Medium Access Control) scheduler in the LTE or 5G protocol stack as part of the baseband processor running within base station 105. Base station 105 may instruct each UE 125a/b/c to multiplex its UCI within its PUSCH data via a command within the PDCCH (Physical Downlink Control Channel) from base station 105 to each UE 125a/b/c. A given base station 105 may only support receiving UCI that is multiplexed within PUSCH, which is a less complex solution than supporting all the demodulation and decoding formats required to support UCI being transmitted via the PUCCH.

Given that each UE 125a/b/c is allocated a limited number of Resource Elements per Resource Grid for its respective PUSCH, and given that some of those Resource Elements must be allocated to UCI data, it is extremely useful to estimate how much data within that PUSCH is available for UCI so that, as more UEs connect to base station 105, the UCI transmitted does not violate its allocation and eat into the UE's PUSCH data. This may result in the base station 105 being unable to decode the PUSCH data from that UE, leading to data decode failure.

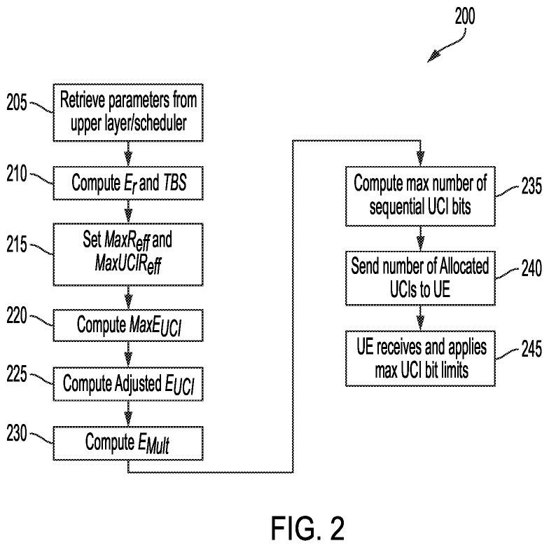

FIG. 2 illustrates an exemplary process 200 for estimating the amount of input data (number of bits) available for transmitting UCI within a UE's PUSCH according to the disclosure. Process 200 may be implemented by the baseband unit within base station 105, which may include an embedded processor that executes machine readable instructions encoded within a non-transitory memory device. As used herein, “non-transitory memory” may refer to any tangible storage medium (as opposed to an electromagnetic or optical signal) and refers to the medium itself, and not to a limitation on data storage (e.g., RAM vs. ROM). For example, non-transitory medium may refer to an embedded volatile memory encoded with instructions whereby the memory may have to be re-loaded with the appropriate machine-readable instructions after being power cycled. Further, if an action is described herein as being done by a referenced component (e.g., “base station 105 transmits . . . ”) it will be understood that this implies that a processor corresponding to the referenced component executes machine-readable instructions to perform the action.

Although three UEs 125a/b/c are illustrated in scenario 100, it will be understood that the number of UEs may vary and that such variations are within the scope of the disclosure.

In step 205, base station 105 retrieves parameters from an upper layer processor: nPRB (number of Physical Resource Blocks allocated to UE 125); nRE_{PTRS} (number of Resource Elements allocated for Phase Tracking Reference Signal symbols); and XOH (number of overhead bits). Base station 105 may store these parameters in an onboard memory for further use in process 200.

In step 210, the base station 105 executes instructions to compute the number of available bits for transmission (Eᵣ) and the Transport Block size (TBS). It may do so according the following relations:

$${E}_{r} = Qm * [ nPRB * ( ( nSym * 12 - nDMRS * ( 6 * nCDM ) - XOH ) - {nRE}_{PTRS} ] \qquad ( Equation 1 )$$

$$TBS = Ninfo + nCRC \qquad ( Equation 2 )$$

$$Ninfo = nRE * R * Qm \qquad ( Equation 3 )$$

where Qm is the modulation order decided by the PUSCH MCS (Modulation and Coding Scheme); nPRB the number of Physical resource blocks retrieved by base station 105 in step 205; nSym the number of PUSCH symbols; nDMRS the number of Demodulation Reference Signal (DMRS) symbols; nCDM the number of coding groups reserved for DMRS, XOH is the number of X Overhead bits retrieved by base station 105 in step 205; nRE_{PTRS} the total number of resource elements (RE) consumed by Phase Tracking Reference Signal (PTRS) symbols retrieved by base station 105 in step 205; Ninfo is the number of information bits to be transmitted, nRE the number of resource elements (RE), R the coding rate, and nCRC the number of Cyclic Redundancy Check parity bits.

In step 215, base station 105 executes instructions to set two parameters necessary to compute the available UCI bits according to the disclosure: MaxR_{eff}, which is the maximum effective coding rate that may be tolerated by a PUSCH decoder within base station 105; and MaxUCIR_{eff}, which is the maximum effective UCI decoding rate that may be tolerated by the PUCCH decoder within base station 105. It will be understood that the PUSCH and PUCCH decoders are PHY (Physical) Layer functions defined by the 3GPP specification. These parameters may be preset within a memory coupled to the processor of base station 105. For example, these parameters may depend on the vendor and specific capabilities of the given base station 105 and affect how it will process and interpreting the incoming UCI data. These parameters are folded into the computations in subsequent steps of process 200.

Even in the case that the UCI data is to be multiplexed within PUSCH, it is necessary to factor in the maximum effective coding rate tolerated by the PUCCH decoder within base station 105 because, regardless of it being multiplexed into PUSCH or transmitted via PUCCH, the UCI data is encoded within the given UE using its PUCCH encoder, which may be a different type of encoder than that used for the PUSCH. For example, under 5G, encoding/decoding of PUSCH data is done using a LDPC (Low Density Parity Check) encoder/decoder, and the encoding/decoding of UCI data is done using either a Reed-Muller (RM) encoder/decoder or a Polar encoder/decoder, depending on the format and number of UCI bits. In the case of LTE (4G), encoding/decoding of PUSCH data is done using a Turbo encoder/decoder, and encoding/decoding of UCI data is done using a Reed-Muller encoder/decoder. Accordingly, regardless of whether system 100 is using LTE or 5G, the encoding/decoding of UCI data is done with different technology than that of the PUSCH data. Accordingly, even if the UCI data is multiplexed into the PUSCH, it is encoded using a different technology than the PUSCH data and must be decoded accordingly.

In step 220, base station 105 executes instructions to compute MaxE_{UCI}, which is the maximum number of UCI bits to be used by the PUSCH corresponding to each UE 125. It may do so according to the following relation:

$${Max E}_{UCI} = \frac{{Max R}_{eff}^{2} * Er - TBS}{{Max R}_{eff}} \qquad ( Equation 4 )$$

where E_{UCI} is the number of encoded UCI bits, Er is computed in Equation 1, TBS is computed in Equation 2, and MaxR_{eff} is set in step 215. The MaxE_{UCI} may be used by the MAC (Medium Access Control) layer of the LTE or 5G protocol stack implemented within base station 105 for the purpose of setting a limit in reserving bits for the UCI data. It may serve as a resource of available bits to encode the selection of CSI part 1, CSI part 2, and HARQ-ACK. The purpose for squaring the reduction of E, in Equation 4 is to reserve bits that would be used for encoding PUSCH data to enable decoding by base station 105 once received over uplink channel UL.

In step 225, base station 105 executes instructions to compute E_{UCI}, adjusted to include

the encoded UCI bits sufficient for satisfying an effective coding rate. Note that the number of available bits for transmission, Eᵣ, does not include the space provided for DMRS (Demodulation Reference Signals) interleaved data. The processor within base station 105 may compute the adjusted E_{UCI} according to the following relation.

$${E}_{u c i}^{adj} = {Max E}_{uci} + Min [ 0 , {Max UciR}_{eff} * E r - ( ( 1 - {Max R}_{eff} * Er ) + TBS ) - {Max E}_{uci} ] \qquad ( Equation 5 )$$

In step 230, the base station 105 executes instructions to compute E_{Mult} (E-Multiplier), which may be used as a reverse multiplier to estimate the number of UCI input bits corresponding to (or based on) the number of encoded UCI bits.

$${E}_{Mult} = Qm * [ nPRB * ( ( nSym ) * 12 - XOH ) - {nRE}_{PTRS} ] / TBS \qquad ( Equation 6 )$$

In step 235, base station 105 executes instructions to compute the maximum number of sequential UCI bits. Given that each UCI type has an independent Beta and subsequent CRC (Cyclic Redundancy Check), the maximum number of UCI bits is computed sequentially and independently for each of the three UCI types (HARQ-ACK, CSI part 1, CSI part 2) and then pooled. Accordingly, each UCI type (Ack, CSI part 1, CSI part 2) is given and processed in its own channel. The processor in base station 105 computes these using the following relations:

$${uci}_{OL} = \frac{{E}_{u c i}^{adj}}{{E}_{Mult} * Beta}$$

$$uc {i}_{O} = MIN [ 17 \; 06 , {uci}_{OL} - L ]$$

where Beta is the scaling element applied to each UCI type input; L is the length of CRC (Cyclic Redundancy Check) and 1706 is the maximum block segmentation length of Polar coding. Further, uci_{OL} is the actual maximum input size including the CRC, and uci_{O} is the actual maximum input size with the CRC amount removed. Accordingly, uci_{O} is the maximum input size for each UCI type.

In step 240, base station 105 transmits the computed maximum number of UCI bits for each UCI type (computed in step 235) to a given UE 125a/b/c. The computed maximum number of UCI bits may vary per UE 125a/b/c, depending on the propagation medium 130a/b/c and the capability of the corresponding UE 125a/b/c. In doing so, base station 105 may transmit this information to each UE 125a/b/c using a vendor-specific information field within the PDCCH (Physical Downlink Control Channel) or PDSCH (Physical Downlink Shared Channel) assigned to that UE.

In step 245, the recipient UE 125a/b/c receives the maximum input bit sizes computed in step 235 and transmitted in step 240, and applies these UCI input bit limit sizes in populating that space within the PUSCH data with the computed UCI data for each of the three UCI types.

What is claimed is:

1. A method for providing a number of input bits for transmission of UCI (Uplink Control Information) from a UE (User Equipment), the method comprising:
computing a number of available bits for transmission and a transport block size TBS;
computing a maximum number of encoded UCI bits based on the number of available bits for transmission and the TBS;
computing a number of encoded UCI bits by adjusting the maximum number of encoded UCI bits in order to satisfy an effective coding rate;
computing a maximum number of UCI input bits, corresponding to the number of encoded UCI bits, based on a computed multiplier; and
transmitting the maximum number of UCI input bits to the UE for uplink transmission of UCI in a Physical Uplink Shared Channel (PUSCH).

2. The method of claim 1, wherein computing the number of available bits for transmission and the TBS is based on a plurality of parameters comprising:
a number of Physical Resource Blocks allocated to the UE (nPRB);
a number of Resource Elements allocated for Phase Tracking Reference Signal symbols (nRE_{PTRS}); and
a number of overhead bits (XOH).

3. The method of claim 1,
wherein computing the maximum number of encoded UCI bits is further based on a maximum effective coding rate corresponding to a PUSCH decoder and based on a maximum effective UCI coding rate corresponding to a Physical Uplink Control Channel (PUCCH) decoder; and
wherein the maximum effective coding rate corresponding to the PUSCH decoder and the maximum effective UCI coding rate corresponding to the PUCCH decoder are received from an upper layer processor of a base station.

4. The method of claim 3, wherein the maximum effective coding rate corresponding to the PUSCH decoder and the maximum effective UCI coding rate corresponding to the PUCCH decoder comprise vendor-specific information.

5. The method of claim 3, wherein the base station comprises a gNodeB.

6. The method of claim 1 further comprising:
computing a maximum number of UCI input bits for each of a plurality of UCI types.

7. The method of claim 6, wherein transmitting the maximum number of UCI input to the UE for uplink transmission of UCI in the PUSCH comprises:
transmitting the maximum number of UCI input bits for each of the plurality of UCI types to the UE for uplink transmission of UCI in the PUSCH.

8. The method of claim 7, wherein the plurality of UCI types comprises:
a hybrid automatic repeat request acknowledgement (HARQ-ACK) information;
a Channel State Information Part 1 (CSI-P1); and
a Channel State Information Part 2 (CSI-P2).

9. The method of claim 6, wherein computing the maximum number of UCI input bits for each of the plurality of UCI types comprises, for each UCI type:
computing a first value corresponding to a maximum number of input bits with a plurality of Cyclic Redundancy Check (CRC) bits; and
computing a second value corresponding to a maximum number of input bits with the plurality of CRC bits removed.

10. The method of claim 1 wherein computing the maximum number of UCI input bits, corresponding to the number of encoded UCI bits, based on a computed multiplier comprises:
backing-out the maximum number of UCI inputs available to the UE prior to encoding.

11. The method of claim 1, further comprising:
receiving the PUSCH with the UCI, from the UE, based on the maximum number of UCI input bits.

12. A non-transitory memory encoded with machine readable instructions that, when executed by a processor, causes the processor to implement a process, comprising:
computing a number of available bits for transmission and a transport block size TBS;
computing a maximum number of encoded UCI bits based on the number of available bits for transmission and the TBS;
computing a number of encoded UCI bits by adjusting the maximum number of encoded UCI bits in order to satisfy an effective coding rate;
computing a maximum number of UCI input bits, corresponding to the number of encoded UCI bits, based on a computed multiplier; and
transmitting the maximum number of UCI input bits to the UE for uplink transmission of UCI in a Physical Uplink Shared Channel (PUSCH).

13. The non-transitory memory of claim 12, wherein the non-transitory memory is coupled to a baseband processor within a base station.

14. The non-transitory memory of claim 13, wherein the base station is a gNodeB.

15. The non-transitory memory of claim 12,
wherein computing the maximum number of encoded UCI bits is further based on a maximum effective coding rate corresponding to a PUSCH decoder and based on a maximum effective UCI coding rate corresponding to a Physical Uplink Control Channel (PUCCH) decoder; and
wherein the maximum effective coding rate corresponding to the PUSCH decoder and the maximum effective UCI coding rate corresponding to the PUCCH decoder are received from an upper layer processor of a base station.

16. The non-transitory memory of claim 15, wherein the maximum effective coding rate corresponding to the PUSCH decoder and the maximum effective UCI coding rate corresponding to the PUCCH decoder comprise vendor-specific information.

17. The non-transitory memory of claim 12, wherein the process further comprises:
computing a maximum number of UCI input bits for each of a plurality of UCI types.

18. The non-transitory memory of claim 17, wherein transmitting the maximum number of UCI input to the UE for uplink transmission of UCI in the PUSCH comprises:
transmitting the maximum number of UCI input bits for each of the plurality of UCI types to the UE for uplink transmission of UCI in the PUSCH.

19. The non-transitory memory of claim 17, wherein computing the maximum number of UCI input bits for each of the plurality of UCI types comprises, for each UCI type:
computing a first value corresponding to a maximum number of input bits with a plurality of Cyclic Redundancy Check (CRC) bits; and
computing a second value corresponding to a maximum number of input bits with the plurality of CRC bits removed.

20. The non-transitory memory of claim 12, wherein the process further comprises:
receiving the PUSCH with the UCI, from the UE, based on the maximum number of UCI input bits.
